(19) United States
(12) Patent Application Publication
(10) Pub. No.: US 2015/0157943 A1
(43) Pub. Date: Jun. 11, 2015

(54) METHOD, SYSTEM AND COMPUTER STORAGE MEDIUM FOR HANDLING OF ACCOUNT THEFT IN ONLINE GAMES

(71) Applicant: TENCENT TECHNOLOGY (SHENZHEN) COMPANY LIMITED, Shenzhen City (CN)

(72) Inventors: Feihong LI, Shenzhen City (CN); Dongxiang ZHOU, Shenzhen City (CN); Yuefeng HE, Shenzhen City (CN)

(21) Appl. No.: 14/620,639

(22) Filed: Feb. 12, 2015

Related U.S. Application Data
(63) Continuation of application No. PCT/CN2013/090524, filed on Dec. 26, 2013.

(30) Foreign Application Priority Data
May 7, 2013 (CN) 201310165624.4

(51) Int. Cl. A63F 13/79

(52) U.S. Cl. CPC A63F 13/79

(57) ABSTRACT

Provided is a method, a system and a computer storage medium for handling of account theft in online games. Said method includes following steps: reading a request for handling of account theft by a system for handling of account theft in online games, wherein said request contains information of an online game account; acquiring abnormal information of virtual property corresponding to said online game account by said system; according to said abnormal information of virtual property, sending an instruction of compensation, corresponding to said online game account, to a running server of said online game. The present disclosure is capable of automatic processing large amount of requests for handling of account theft in online games, which improves efficiency and accuracy as compared to manual processing.

### TECHNICAL FIELD

This application claims priority to Chinese Application No. 201310165624.4, “METHOD AND SYSTEM FOR HANDLING OF ACCOUNT THEFT IN ONLINE GAMES”, filed on May 7, 2013, which is hereby incorporated by reference in its entirety.

The present disclosure relates to computer technology field, especially relates to a method and system for handling of account theft in online games.

### BACKGROUND OF THE INVENTION

An online game refers to an individual participative and sustainable multiplayer game, which takes internet as transmission medium, takes game running servers and user computers as processing terminals, and takes game client software as an information interactive window to achieve objects of entertainment, relaxation, communication and making virtual achievements. The online game has abundant expressive forms, and the virtual property of the online game refers to items having a certain value in use in virtual online game environment, including a virtual character in a game account created by a game player, as well as including virtual currency and virtual items owned by the virtual character in virtual world.

With the increasing of the quantity of online players in online games, virtual property stolen problem in online games is getting more and more severe. To the problem herein, the prior art solution is as follows: a customer service staff manually checks if an account theft behavior happened in the online game according to the request of a game player; if so, the customer service staff further manually checks if the virtual property of said online game account is stolen, if the virtual property is stolen, the customer service staff sends instructions to the running server, such as an instruction of compensation and so on. The prior art solution has following disadvantages: the efficiency of manual processing is low, and it is easy to make mistakes, which can not satisfy the demand of processing large amount of requests for virtual property theft existing in online games.

### SUMMARY OF THE INVENITON

In view of defects existing in the prior art mentioned above, in one aspect, the present disclosure provides a method for handling of account theft in online games which is capable of automatic processing large amount of requests for handling of account theft in online games, so as to improve efficiency and accuracy as compared to manual processing:

A method for handling of account theft in online games, including following steps:

reading a request for handling of account theft by a system for handling of account theft in online games, wherein said request contains information of an online game account;

acquiring abnormal information of virtual property corresponding to said online game account by said system; and

according to said abnormal information of virtual property, sending an instruction of compensation, corresponding to said online game account, to a running server of said online game by said system.

In another aspect, the present disclosure provides a system for handling of account theft in online game, including:

a request reading module, used for reading a request for handling of account theft, wherein said request contains information of an online game account;

an abnormal information acquiring module, used for acquiring information of virtual property corresponding to said online game account; and

an instruction sending module, used for sending an instruction of compensation, corresponding to said online game account, to a running server of said online game according to said abnormal information of virtual property.

In another aspect, the present disclosure provides a non-transitory computer readable storage medium for handling of account theft in online games, including computer executable instructions, said computer executable instructions are used for executing a method for handling of account theft in online games, wherein, said method includes following steps:

reading a request for handling of account theft by a system for handling of account theft in online games, wherein said request contains information of an online game account;

acquiring abnormal information of virtual property corresponding to said online game account by said system; and

according to said abnormal information of virtual property, sending an instruction of compensation, corresponding to said online game account, to a running server of said online game by said system.

The method, system and non-transitory computer readable storage medium for handling of account theft in online games mentioned above are capable of acquiring abnormal information of virtual property corresponding to an online game account by means of reading a request for handling of account theft in an online game and analyzing corresponding online game account, and then sending an instruction of compensation corresponding to said online game account to a running server of the online game. The technical solution provided in the present disclosure does not require manual intervention but is capable of automatic processing large amount of requests for handling of account theft in online games, which improves efficiency and accuracy, as compared to manual processing in the prior art.

### BRIEF DESCRIPTION OF THE DRAWS

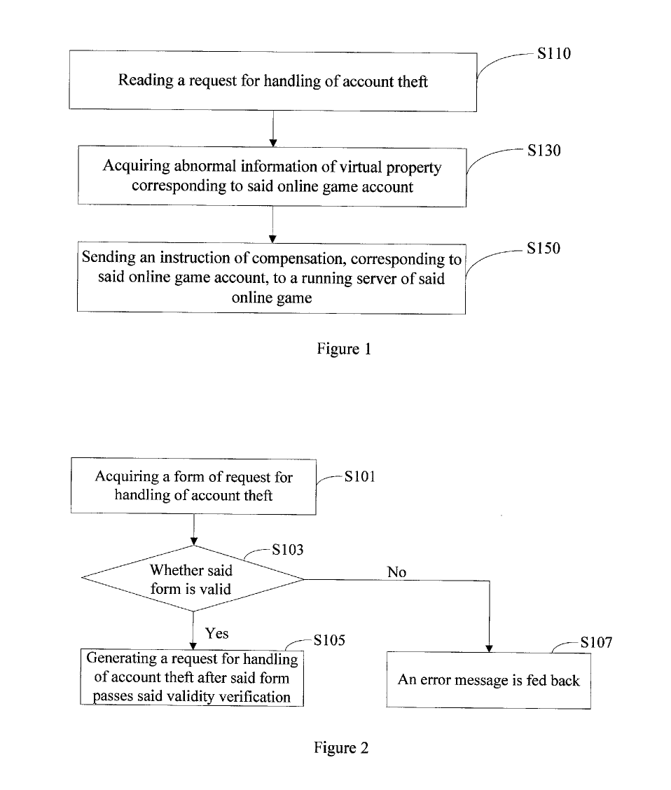

FIG. 1 is a flow diagram illustrating the method for handling of account theft in online games according to one embodiment of the present invention;

FIG. 2 is a flow diagram illustrating the process of executing validity verification to a form of the request for handling of account theft according to one embodiment of the present invention;

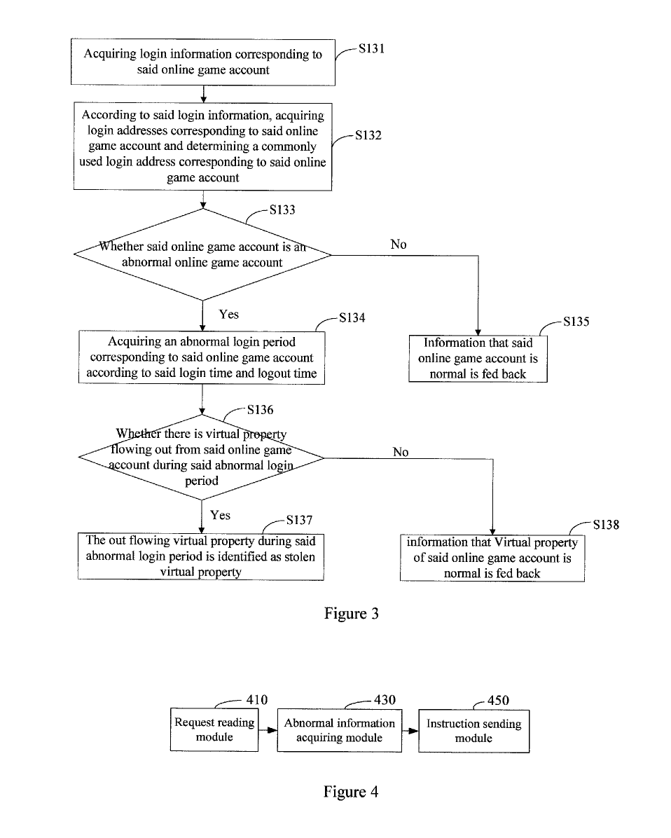

FIG. 3 is a flow diagram illustrating the process of acquiring abnormal information of virtual property corresponding to an online game account according to one embodiment of the present invention;

FIG. 4 is a structure diagram illustrating a system for handling of account theft in online games according to one embodiment of the present invention;

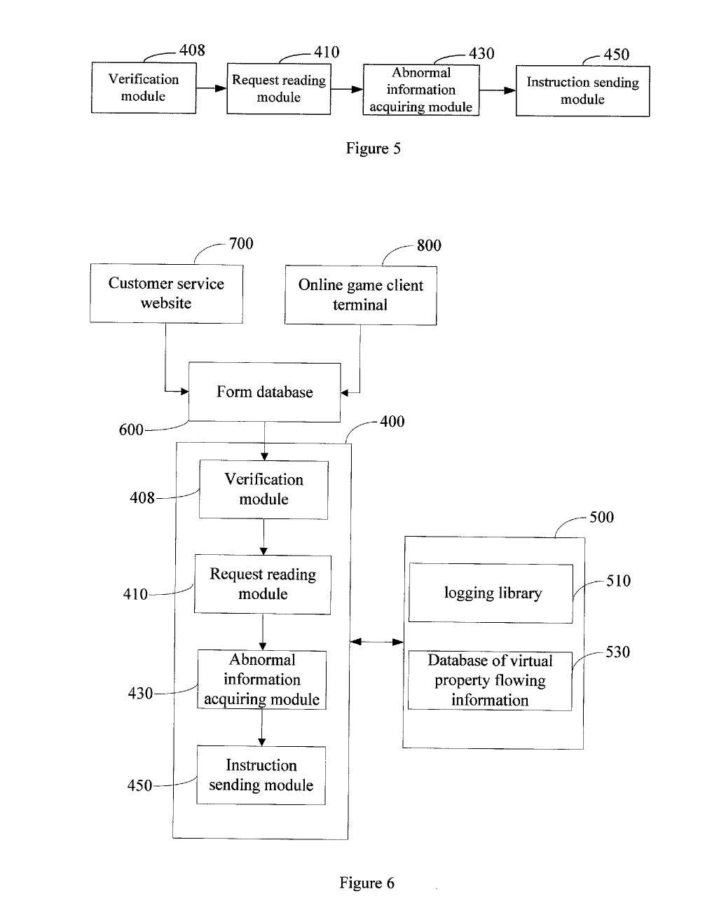

FIG. 5 is a structure diagram illustrating a system for handling of account theft in online games according to another embodiment of the present invention;

FIG. 6 shows a diagram of application scenario for the system for handling of account theft in online games as shown in FIG. 5;

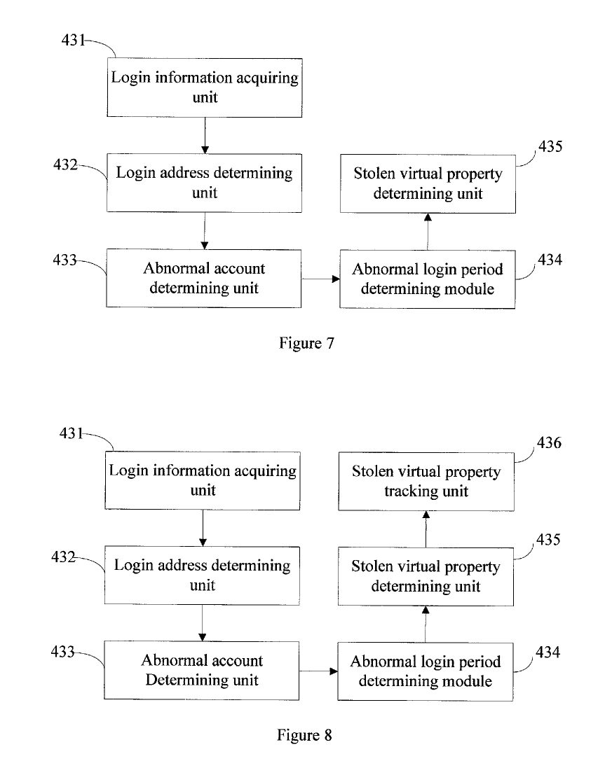

FIG. 7 is a structure diagram illustrating an abnormal information acquiring module in the system for handling of account theft in online games according to one embodiment of the present invention;

FIG. 8 is a structure diagram illustrating an abnormal information acquiring module in the system for handling of account theft in online games according to another embodiment of the present invention; and

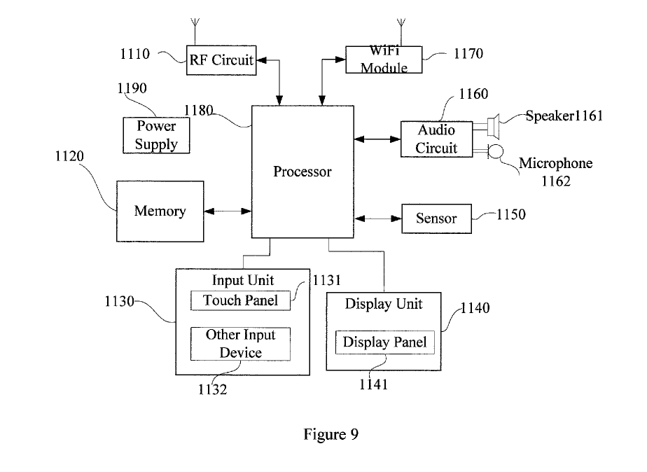

FIG. 9 is a structure diagram illustrating a processing terminal for handling of account theft in online games according to one embodiment of the present invention.

### DETAILED DESCRIPTION OF THE PREFERRED EMBODIMENTS

In order to make the purpose, technical solutions and advantages of the present disclosure to be understood more clearly, the present disclosure will be described in further details with the accompanying drawings and the following embodiments. It should be understood that the specific embodiments described herein are merely examples to illustrate the disclosure, not to limit the present disclosure.

As shown in FIG. 1, according to one embodiment of the present invention, the method for handling of account theft in online games includes following steps:

Step S110, reading a request for handling of account theft by a system for handling of account theft in online games.

In this embodiment, said request herein contains information of an online game account. Said request herein may be read by said system, but not limited to, by means of Linux (Linux is a free and open-source, Unix-like operating system) timing technique and python (python is an object-oriented, literal style computer programming language) timing technique, so as to realize an automatic processing of the request for handling of account theft without manual intervention.

Step S130, acquiring abnormal information of virtual property corresponding to said online game account by said system.

Said abnormal information of virtual property contains information whether said online game account is abnormal, information whether the virtual property corresponding to said online game account is abnormal, information of the virtual property stolen, and so on. It is possible to process said request specifically according to said abnormal information of virtual property.

Step S150, according to said abnormal information of virtual property, sending an instruction of compensation, corresponding to said online game account, to a running server of said online game by said system.

According to said abnormal information of virtual property, it can be known whether said online game account is stolen and the destination account to which the corresponding virtual property flows. Therefore, an instruction of compensation, corresponding to said online game account, may be sent to a running server of said online game, so as to compensate for the online game account stolen. Furthermore, after receiving said instruction of compensation, said running server may execute said instruction of compensation to said online game account, for instance, said running server may send an instruction of compensation to compensate preset quantities of virtual property or compensate the part of the out flowing virtual property of said online game account; alternatively, said running server may delete a certain amount of virtual property from the destination online game account to which said stolen virtual property flows, and compensate said certain amount of virtual property to the online game account stolen.

In this embodiment, said abnormal information of virtual property corresponding to said online game account is acquired by means of reading said request for handling of account theft, and an instruction of compensation is sent to said running server of said online game according to said abnormal information of virtual property, so as to realize the automatic compensation operation to said stolen online game account. The technical solution provided in this embodiment does not require manual intervention but is capable of automatic processing large amount of requests for handling of virtual property theft in online games, so that the efficiency and accuracy of handling of account theft in online games are improved.

In one embodiment as shown in FIG. 2, prior to the step S110, a process of executing validity verification to the form of said request for handling of account theft is implemented by said system, the process of executing validity verification further includes following steps:

Step S101, acquiring a form of request for handling of account theft by said system.

When a user has found account theft in an online game account, the user may fill a form of request via a customer service website of said online game or via an online game client terminal. Said form of request contains personal information and character information, and so on, which were filled by the user. Said filled form of request is uploaded to the running server so as to be handled. After receiving said form of request, the running server is capable of saving said form of request into a form database.

Step S103, executing validity verification to said form of request for handling of account theft by said system.

Said validity verification refers to the process that the running server judges, according to said corresponding form of request, whether said form of request for handling of account theft satisfies conditions of handling of account theft. In an embodiment, said step of executing validity verification to said form of request for handling of account theft is specified as the follows: judging whether said form of request for handling of account theft satisfies one or any combinations of following conditions: whether said online game account contained in said form of request for handling of account theft is a valid account; whether the name of an online game character corresponding to said online game account is correct; whether the level of an online game character corresponding to said online game account reaches a preset level; if so, said form of request for handling of account theft passes said validity verification. It should be understood that the condition for judging said form of request for handling of account theft is not limited by those conditions mentioned above, but may further include other conditions, for example, whether said form of request for handling of account theft is a form repeatedly received from the same online game account in a preset period; whether the time length of filling a form of request for handling of account theft is beyond the preset length of time as compared to the time length of validity verification, and so on.

S105, generating a request for handling of account theft after said form passes said validity verification by said system.

In this embodiment, said generated request may be saved into a database of account theft. Therefore, said database of account theft saves requests for handling of account theft which have passed said validity verification, and said saved requests may be extracted from said database to be handled. All forms of request are screened through said validity verification, and only forms of request that have passed validity verification can be processed, so that the efficiency and accuracy of processing requests for handling of account theft are improved.

Step S107, an error message is fed back by said system if said request for handling of account theft does not pass said validity verification.

In one embodiment as shown in FIG. 3, the process of acquiring abnormal information of virtual property corresponding to an online game account includes following steps:

Step S131, acquiring login information corresponding to said online game account by said system.

In this embodiment, when an online game account logs in and logs out from said online game, the login information is saved into a logging library, and said login information contains login time, logout time and login addresses of said online game account.

Step S132, according to said login information, acquiring login addresses corresponding to said online game account by said system and determining a commonly used login address corresponding to said online game account.

Said login address corresponding to said online game account is acquired from said login information, wherein, said login address may be an IP address where said online game account logs in, or an area where the IP address is located. Then, the login address, which has the most login times or the longest playtime, is identified as the commonly used login address.

Step S133, judging whether said online game account is an abnormal online game account by said system, if so, turning to step S134, otherwise turning to step S135.

In this embodiment, the process of judging whether an online game account is an abnormal online game account is based on whether there is a login address different from said commonly used login addresses contained in said login addresses, if so, the online game account is identified as an abnormal online game account. The above process herein is not used to limit but just taken as an implementation to illustrate the technical solution of the present disclosure. For example, the process of judging whether an online game account is an abnormal online game account may alternatively be based on whether there is an abnormal login time, whether there are multiple times of input error of the password of an online game account, and so on.

Step S134, acquiring the login time and logout time contained in said login information corresponding to said login address which is different from said commonly used login address by said system, and then acquiring an abnormal login period corresponding to said online game account according to said login time and logout time, and the virtual property may flow out from said online game account during said abnormal login period.

Step S135, feeding back the information that said online game account is normal by said system.

If an online game account is not identified as an abnormal online game account, it means that said online game account is not stolen. The compensation operation will not be processed to said online game account, and the information that said online game account is normal will be fed back.

Step S136, acquiring virtual property flowing information corresponding to said online game account by said system, and judging whether there is virtual property flowing out from said online game account during said abnormal login period according to said virtual property flowing information.

Said virtual property flowing information contains the flowing out and flowing in information of the virtual property corresponding to said online game account. The running server is capable of judging whether there is virtual property flowing out from said online game account during said abnormal login period according to said virtual property flowing information so as to identify the stolen virtual property.

Step S137, if there is virtual property flowing out during said abnormal login period, the out flowing virtual property during said abnormal login period is identified as stolen virtual property by said system.

Step S138, if there is no virtual property out flowing during said abnormal login period, the information that said online game account is normal is fed back by said system.

In this embodiment, when the out flowing virtual property during said abnormal login period is identified as stolen virtual property, an instruction of adding said stolen virtual property to said abnormal online game account may be sent to the running server of said online game. After receiving said instruction herein, said running server of said online game adds said stolen virtual property to said abnormal online game account accordingly, so as to complete the handling of account theft.

In this embodiment, first acquiring the login addresses according to the login information of said online game account so as to determine the commonly used login address corresponding to said online game account; then judging whether said online game account is abnormal according to login addresses. When said online game account is abnormal, the abnormal login period is determined according to login time and logout time, and then said stolen virtual property is determined according to said virtual property flowing information during said abnormal login period. At last said handling of account theft is completed by adding, to said abnormal online game account, virtual property corresponding to said stolen virtual property, so as to realize the automatic processing without manual checking and processing, and the efficiency of processing is improved.

In another embodiment, after determining that the out flowing virtual property during an abnormal login period is stolen virtual property, the virtual property flowing information is acquired, and the destination online game account is identified according to said virtual property flowing information.

Furthermore, after the destination online game account is identified according to said virtual property flowing information, an instruction of deleting said stolen virtual property from said destination online game account and an instruction of adding said stolen virtual property to said abnormal online game account are sent to said running server of said online game. After receiving said instructions, said running server of said online game will delete said stolen virtual property from said destination online game account and add said stolen virtual property to said abnormal online game account.

In this embodiment, the stolen virtual property of said online account can be tracked so as to achieve the object of compensating the stolen virtual property to said abnormal online game account, as well as deleting illegal profits of said destination online game account, which improves the accuracy of processing.

In one embodiment as shown in FIG. 4, a system for handling of account theft in online games is provided, including:

A request reading module 410, used for reading a request for handling of account theft, wherein said request contains information of an online game account.

An abnormal information acquiring module 430, used for acquiring information of virtual property corresponding to said online game account.

An instruction sending module 450, used for sending an instruction of compensation, corresponding to said online game account, to a running server of said online game according to said abnormal information of virtual property.

In another embodiment as shown in FIG. 5, a system for handling of account theft in online games is provided, and on the basis of the embodiment as shown in FIG. 4, said system further includes a verification module 408, used for acquiring a form of request for handling of account theft, executing validity verification to said form of request for handling of account theft, and generating said request for handling of account theft if said form of request passes said validity verification.

Furthermore, in one embodiment, said verification module 408 is used for judging whether said form of request for handling of account theft satisfies one or any combinations of following conditions: whether said online game account contained in said form of request for handling of account theft is a valid account; whether the name of an online game character corresponding to said online game account is correct; whether the level of an online game character corresponding to said online game account reaches to a preset level; if so, said form of request for handling of account theft passes said validity verification.

FIG. 6 shows an application scenario for the system 400 for handling of account theft in online games as shown in FIG. 5: when an online game player finds that the virtual property of his/her online game account is stolen, he/she may complain through the customer service website 700 or the online game client terminal 800, and fill a form of request for handling of account theft; and then the customer service website 700 or the online game client terminal 800 will send said form of request to a form database 600 for storage.

The system 400 for handling of account theft in online games includes a verification module 408, a request reading module 410, an abnormal information acquiring module 430, and an instruction sending module 450. The verification module 408 acquires a form of request for handling of account theft, executes validity verification to said form of request for handling of account theft, and generates a request for handling of account theft if the form passes the verification. The request reading module 410 reads the request for handling of account theft by means of Linux timing technique and python timing technique, wherein the request for handling of account theft contains information of the online game account. The abnormal information acquiring module 430 acquires the login information of the online account saved in the logging library 510 of the running server 500 of the online game and acquires the abnormal information of the virtual property, saved in database 530 of virtual property flowing information, corresponding to the online game account. The instruction sending module 450 sends the instruction of compensation, corresponding to the online game account, to the running server 500 of the online game according to the abnormal information of virtual property. After receiving the instruction of compensation, the running server 500 of the online game executes processes such as adding or deleting virtual property, and so on.

In one embodiment as shown in FIG. 7, the abnormal information acquiring module 430 includes:

A login information acquiring unit 431, used for acquiring login information corresponding to said online game account;

A login address determining unit 432, used for acquiring login addresses corresponding to said online game account and determining a commonly used login address corresponding to said online game account according to said login information;

An abnormal account determining unit 433, used for judging whether there is a login address, which is different from said commonly used login address, contained in said login addresses; if so, said online game account is judged as an abnormal online game account.

An abnormal login period determining module 434, used for acquiring login time and logout time contained in said login information corresponding to said login address which is different from said commonly used login address, and then acquiring an abnormal login period corresponding to said online game account according to said login time and logout time when said online game account is an abnormal online game account;

A stolen virtual property determining unit 435, used for acquiring virtual property flowing information corresponding to said online game account, and judging whether there is virtual property out flowing from said online game account during said abnormal login period according to said virtual property flowing information; if so, said virtual property out flowing during said abnormal login period is judged as stolen virtual property.

Furthermore, in this embodiment, when the stolen virtual property determining unit 435 determines that the out flowing virtual property during abnormal login period is the stolen virtual property, the instruction sending module 450 sends an instruction of compensation to the running server of the online game to add the stolen virtual property to the abnormal online game account. After receiving said instruction herein, the running server of the online game adds the stolen virtual property to the abnormal online game account so as to complete the handling of account theft.

In another embodiment as shown in FIG. 8, the abnormal information acquiring module 430 further includes a stolen virtual property tracking unit 436, used for acquiring the flowing information of the stolen virtual property and determining a destination online game account, to which said stolen virtual property flows, according to said abnormal information of virtual property.

Furthermore, in this embodiment, when the stolen virtual property determining unit 435 determines that the out flowing virtual property during abnormal login period is the stolen virtual property and the stolen virtual property tracking unit determines the destination online game account to which the stolen virtual property flows, the instruction sending module 450 sends, to the running server of the online game, an instruction of deleting the stolen virtual property from the destination online game account and an instruction of adding the stolen virtual property to the abnormal online game account. After receiving said instructions, the running server of the online game account will delete the stolen virtual property from the destination online game account and add the stolen virtual property to the abnormal online game account.

It should be understood by those skilled in the art that all or part of the processes of preferred embodiments disclosed above may be realized through relevant hardware commanded by computer program instructions. Said program may be saved in a computer readable storage medium, and said program may include the processes of the preferred embodiments mentioned above when it is executed. Wherein, said storage medium may be a diskette, optical disk, ROM (Read-Only Memory) or RAM (Random Access Memory), and so on.

In one embodiment as shown in FIG. 9, a processing terminal for handling of account theft in online games is further provided, in order to illustrate said terminal more clearly, what is shown in FIG. 9 is a part of said terminal relevant to this embodiment of the present invention, for the technical details which are uncovered, please refer to embodiments involving methods of the present disclosure. Said terminal may be any terminal devices such as a mobile phone, tablet PC, PDA (personal digital assistant), POS (point of sales), on-board computer, and so on. Taking a mobile phone, a mobile terminal, as an example:

FIG. 9 is a structure diagram illustrating a portion of mobile phone relevant to the terminal for handling of account theft in online games according to one embodiment of the present invention. As shown in FIG. 9, the mobile phone includes: RF (Radio Frequency, RF) circuit 1110, a memory 1120, an input unit 1130, a display unit 1140, a sensor 1150, an audio circuit 1160, a wireless fidelity (wireless fidelity, Wi-Fi) module 1170, a processor 1180, a power supply 1190 and so on. It should be understood by those skilled in the art that, the mobile phone is not limited by the structure of the mobile phone shown in FIG. 9, but may include more or less components, or any combinations thereof, or the components may be arranged in different layouts.

Various components of the mobile phone will be described in more details with reference to the FIG. 9:

RF circuit 1110 is used to send and receive signals in process of sending and receiving messages or making phone calls, preferably, after receiving downlink information from a base station, the RF circuit 1110 sends said downlink information to the processor 1180 for processing; on the other hand, the designed uplink data is sent to the base station. Usually, the RF circuit includes but is not limited to, an antenna circuitry, at least one amplifier, a transceiver, a coupler, a low noise amplifier (LNA), a duplexer, and so on. Moreover, the RF circuit 1110 may also communicate with other devices through wireless communication and network. The wireless communication mentioned above may use any communication or agreement which includes but is not limited to GSM (Global System for Mobile Communications), GPRS (General Packet Radio Service), CDMA (Code Division Multiple Access), WCDMA (Wideband Code Division Multiple Access), LTE (Long Term Evolution), e-mail, SMS (Short Messaging Service), and son on.

The memory 1120 is used for saving software programs and modules; the processor 1180 executes various functions of the mobile phone and data processing applications by running said software programs and modules saved in the memory 1120. Memory 1120 may mainly include a program storage area and a data storage area, wherein, said program storage area may store an operating system program, application program required by at least one function (such as sound playback, image playback, etc.), and so on; said data storage area may store data created according to the usage of the mobile phone (such as audio data, phone book, etc.). In addition, said memory 1120 may include a high-speed random access memory, and may further include a non-volatile memory, such as at least one of disk storage devices, flash memory devices and other volatile solid state memory devices.

Said input unit 1130 is used for receiving numbers or character information entered by the user, and for generating key signal inputs relevant to user settings and function control of the mobile phone 1100. Particularly, said input unit 1130 may include a touch panel 1131 and other input devices 1132. Said touch panel 1131, also known as a touch screen, is used for collecting the user's touch operations thereon or nearby (for example, a user operates on or near said touch panel 1131 using a finger, a stylus, and any other suitable objects or attachments), and driving corresponding connecting devices based on a preset program. Preferably, said touch panel 1131 may include a touch detection unit and a touch controller. Wherein the touch detection unit detects the touch position of the user, and detects signals generated by the touch operation, and then the signals are sent to a touch controller; the touch controller receives the touch information from said touch detection unit and converts said touch information into contact coordinates, and then sends said contact coordinates to said processor 1180, said touch controller is also able to receive instructions from said processer 1180 and execute said instructions. Wherein, said touch panel 1131 may be realized in various manners such as resistance-type, capacitance-type, infrared-ray and surface acoustic wave. In addition to said touch panel 1131, said input unit 1130 may further include other input device 1132. Particularly, said other input device 1132 includes but is not limited to one or more of a physical keyboard, function keys (such as volume control buttons, switch buttons, etc.), a trackball, a mouse and a operating lever.

Said display unit 1140 is used for displaying the information entered by a user or information provided to a user as well as various menus of the mobile phone. Said display unit 1140 may include a display panel 1141, particularly, said display panel 1141 may be configured by a LCD (Liquid Crystal Display), an OLED (Organic Light-Emitting Diode) or other forms of display panel. Preferably, said touch panel 1131 covers said display panel 1141, after detecting a touch operation thereon or nearby, said touch panel 1131 generates a touch signal and sends said touch signal to said processor 1180 so as to determine the type of touch event, and then said processor 1180 provides a corresponding visual output on said display panel 1141 according to the type of touch event. Although in the embodiment shown in FIG. 9, said touch panel 1131 and said display panel 1141 are embodied as two separate components to achieve input and output functions of the mobile phone, in some embodiments, said touch panel 1131 and said display panel 1141 may be integrated to achieve input and output functions of the mobile phone.

The mobile phone 1100 may further include at least one sensor 1150, such as an optical sensor, motion sensor and other types of sensors. Particularly, the optical sensor may include an ambient light sensor and a proximity sensor, wherein, the ambient light sensor can adjust the brightness of the display panel 1141 according to the brightness of ambient light, and the proximity sensor can close said display panel 1141 and/or backlight when the mobile phone moves to the ear. As a motion sensor, accelerometer sensor can detect the value of acceleration in each direction (typically three axis), and can detect the magnitude and direction of gravity when it is in static state, and further can be used for applications involving identifying the phone posture (such as horizontal and vertical screen switching, related games, magnetometer calibration posture), vibration recognition related functions (e.g. pedometer, percussion), etc.; as for other sensors which may be equipped in the mobile phone, such as a gyroscope, barometer, hygrometer, thermometer, infrared sensor and so on, they will not be described here in details.

Said audio circuit 1160, speaker 1161, microphone 1162 can provide an audio interface between the user and the mobile phone. Said audio circuit 1160 can receive audio data and convert the audio data into electrical signals, and then transmit said electrical signals to said speaker 1161. Said speaker 1161 converts said electrical signals to audio signals to be output; on the other hand, said microphone 1162 converts sound signals collected to electrical signals, and after receiving said electrical signals the audio circuit 1160 converts said electrical signals to audio data, and outputs said audio data to the processor 1180 for processing, and then said audio data are sent to another phone via said RF circuit 1110, or sent to said memory 1120 for further processing.

Wi-Fi belongs to a short-range wireless transmission technology, and a mobile phone can help the user to send and receive email, browse the web and access streaming media, and so on via the Wi-Fi module 1170, which provides wireless broadband Internet access to the user. Although FIG. 9 shows a Wi-Fi module 1170, but it should be understood that it is not an essential part of said mobile phone 1100, but may be omitted as needed within the scope of unchanging the essence of the present disclosure.

Said processor 1180 is the control center of the mobile phone, used for connecting each part of the mobile phone through a variety of interfaces and connections, and executing various functions of the mobile phone and data processing to monitor the overall of the mobile phone by running or executing software programs and/or modules stored in the memory 1120 and calling in data stored in the memory 1120. Preferably, said processor 1180 may include one or more processing units; preferably, an application processor and a modem processor may be integrated in said processor 1180, wherein, said application processor mainly processes the operating system, user interface and applications, and said modem processor mainly deals with wireless communications. It should be understood that said modem processor mentioned above may be not integrated into said processor.

Said mobile phone 1100 further includes a power supply 1190 (such as a battery), used for supplying the power to various parts, preferably, said power supply system is logically connected to said processor 1180 via the power management system, thereby realizing functions such as charging management, discharging management, power consumption management, and so on via the power management system.

Although it is not shown, said phone 1100 may further include a camera, Bluetooth module, etc., which are not discussed in details here.

In one embodiment of the present invention, said processor 1180 contained in the terminal further includes following functions: reading a request for handling of account theft, wherein the request for handling of account theft contains information of an online game account; acquiring the abnormal information of virtual property corresponding to the online game account; sending an instruction of compensation corresponding to the online game account, to the online game running server, according to the abnormal information of virtual property.

In another embodiment, said processor 1180 further includes following functions: prior to reading a request for handling of account theft, acquiring a form of request for handling of account theft, and executing validity verification to said form of request for handling of account theft; generating said request for handling of account theft if said form of request passes said validity verification. Particularly, said processor 1180 may judge whether said form of request for handling of account theft satisfies one or any combinations of following conditions: whether said online game account contained in said form of request for handling of account theft is a valid account; whether the name of an online game character corresponding to said online game account is correct; whether the level of said online game character corresponding to said online game account reaches a preset level; and if so, said form of request for handling of account theft passes said validity verification.

In one embodiment, said processor 1180 owns the function of acquiring abnormal information of virtual property corresponding to said online game account, and said function particularly includes: acquiring login information corresponding to said online game account; according to said login information, acquiring login addresses corresponding to said online game account and determining a commonly used login address corresponding to said online game account; and judging whether said online game account is an abnormal online game account; if so, acquiring login time and logout time contained in said login information corresponding to said login address which is different from said commonly used login address, and then acquiring an abnormal login period corresponding to said online game account according to said login time and logout time; acquiring virtual property flowing information corresponding to said online game account, and judging whether there is virtual property flowing out from said online game account during said abnormal login period, according to said virtual property flowing information; and if so, said out flowing virtual property during said abnormal login period is judged as stolen virtual property. Furthermore, after said out flowing virtual property during said abnormal login period is judged as stolen virtual property by said processor 1180, said processor 1180 may send, to said running server of said online game, an instruction of adding said stolen virtual property to said abnormal online game account. After receiving said instruction, the running server of said online game adds said stolen virtual property to said abnormal online game account, so as to complete the handling of account theft.

In another embodiment, said processor 1180 further includes following functions: after said out flowing virtual property during said abnormal login period is judged as stolen virtual property, said stolen virtual property flowing information may be acquired, and according to said abnormal information of virtual property, determining a destination online game account to which said stolen virtual property flows. Furthermore, in this embodiment, after a destination online game account to which said stolen virtual property flows, is determined according to said abnormal information of virtual property by said processor 1180, said processor 1180 may send, to said running server of said online game, an instruction of deleting said stolen virtual property from said destination online game account; and send, to said running server of said online game, an instruction of adding said stolen virtual property to said abnormal online game account. After receiving said instructions, the running server of the online game will delete said stolen virtual property from said destination online game account and add said stolen virtual property to said abnormal online game account.

It should be understood by those skilled in the art that what described above are preferred embodiments of the present invention. Various modifications and replacements may be made therein without departing from the theory of the present disclosure, which should also be seen in the scope of the present disclosure.

1-26. (canceled)

27. A method for handling of account theft in online games, comprising:
reading a request for handling of account theft by a system for handling of account theft in online games, wherein said request contains information of an online game account;
acquiring abnormal information of virtual property corresponding to said online game account by said system;
according to said abnormal information of virtual property, sending an instruction of compensation, corresponding to said online game account, to a running server of said online game by said system; and
acquiring a form of request for handling of account theft by said system, and executing validity verification to said form of request for handling of account theft; generating said request for handling of account theft if said form of request passes said validity verification.

28. The method for handling of account theft in online games according to claim 27, wherein, said executing validity verification to said form of request for handling of account theft comprises following step:
judging whether said form of request for handling of account theft satisfies one or any combinations of following conditions by said system:
whether said online game account contained in said form of request for handling of account theft is a valid account;
whether a name of an online game character corresponding to said online game account is correct;
whether a level of said online game character corresponding to said online game account reaches a preset level; and
if so, said form of request for handling of account theft passes said validity verification.

29. The method for handling of account theft in online games according to claim 27, wherein, said step of acquiring abnormal information of virtual property corresponding to said online game account by said system comprises following sub-steps:
acquiring login information corresponding to said online game account by said system;
according to said login information, acquiring login addresses corresponding to said online game account and determining a commonly used login address corresponding to said online game account by said system; and
judging whether there is a login address, which is different from said commonly used login address, contained in said login addresses by said system; if so, said online game account is judged as an abnormal online game account.

30. The method for handling of account theft in online games according to claim 29, wherein, said step of acquiring abnormal information of virtual property corresponding to said online game account by said system further comprises following sub-steps:
when said online game account is an abnormal online game account, acquiring login time and logout time contained in said login information corresponding to said login address which is different from said commonly used login address, and then acquiring an abnormal login period corresponding to said online game account according to said login time and logout time by said system;
acquiring virtual property flowing information corresponding to said online game account by said system, and judging whether there is virtual property flowing out from said online game account during said abnormal login period, according to said virtual property flowing information; and
if so, said out flowing virtual property during said abnormal login period is judged as stolen virtual property.

31. The method for handling of account theft in online games according to claim 30, wherein, said step of according to said abnormal information of virtual property, sending an instruction of compensation, corresponding to said online game account, to the running server of said online game according to said abnormal information of virtual property by said system is specified as the following step:
sending, to said running server of said online game, an instruction of adding said stolen virtual property to said abnormal online game account by said system.

32. The method for handling of account theft in online games according to claim 30, wherein, after said sub-step of said out flowing virtual property during said abnormal login period is judged as stolen virtual property, said method further comprises following sub-steps:
acquiring said stolen virtual property flowing information by said system, and according to said abnormal information of virtual property, determining a destination online game account to which said stolen virtual property flows.

33. The method for handling of account theft in online games according to claim 32, wherein, the step of sending said instruction of compensation, corresponding to said online game account, to the running server of said online game according to said abnormal information of virtual property by said system is specified as the following steps:
sending, to said running server of said online game, an instruction of deleting said stolen virtual property from said destination online game account; and sending, to said running server of said online game, an instruction of adding said stolen virtual property to said abnormal online game account by said system.

34. A system for handling of account theft in online games, wherein, said system comprises:
a request reading module, used for reading a request for handling of account theft, and said request contains information of an online game account;
an abnormal information acquiring module, used for acquiring information of virtual property corresponding to said online game account;
an instruction sending module, used for sending an instruction of compensation, corresponding to said online game account, to a running server of said online game according to said abnormal information of virtual property; and
a verification module, used for acquiring a form of request for handling of account theft, executing validity verification to said form of request for handling of account theft, and generating said request for handling of account theft if said form of request passes said validity verification.

35. The system for handling of account theft in online games according to claim 34, wherein, said verification module is used for judging whether said form of request for handling of account theft satisfies one or any combinations of following conditions:
whether said online game account contained in said form of request for handling of account theft is a valid account;
whether a name of an online game character corresponding to said online game account is correct;
whether a level of an online game character corresponding to said online game account reaches a preset level; and
if so, said form of request for handling of account theft passes said validity verification.

36. The system for handling of account theft in online games according to claim 34, wherein, said abnormal information acquiring module comprises:
a login information acquiring unit, used for acquiring login information corresponding to said online game account;
a login address determining unit, used for acquiring login addresses corresponding to said online game account and determining a commonly used login address corresponding to said online game account according to said login information; and
an abnormal account determining unit, used for judging whether there is a login address, which is different from said commonly used login address, contained in said login addresses; if so, said online game account is judged as an abnormal online game account.

37. The system for handling of account theft in online games according to claim 36, wherein, said abnormal information acquiring module further comprises:
an abnormal login period determining unit, when said online game account is an abnormal online game account, said abnormal login period determining unit is used for acquiring login time and logout time, contained in said login information, corresponding to said login address which is different from said commonly used login address, and then acquiring an abnormal login period corresponding to said online game account according to said login time and logout time; and
a stolen virtual property determining unit, used for acquiring virtual property flowing information corresponding to said online game account, and judging whether there is virtual property flowing out from said online game account during said abnormal login period according to said virtual property flowing information; if so, said out flowing virtual property during said abnormal login period is judged as stolen virtual property.

38. The system for handling of account theft in online games according to claim 37, wherein, said instruction sending module is used for sending an instruction, which is adding said stolen virtual property to said abnormal online game account, to said running server of said online game.

39. The system for handling of account theft in online games according to claim 37, wherein, said abnormal information acquiring module further comprises:
a stolen virtual property tracking unit, used for acquiring the flowing information of said stolen virtual property, and determining a destination online game account to which said stolen virtual property flows, according to said abnormal information of virtual property.

40. The system for handling of account theft in online games according to claim 39, wherein, said instruction sending module is used for sending, to said running server of said online game, an instruction of deleting said stolen virtual property in said destination online game account; and sending, to said running server of said online game, an instruction of adding said stolen virtual property to said abnormal online game account.

41. A non-transitory computer readable storage medium, including computer executable instructions, said computer executable instructions are used for executing a method for handling of account theft in online games, wherein, said method comprises following steps:
reading a request for handling of account theft by a system for handling of account theft in online games, wherein said request contains information of an online game account;
acquiring abnormal information of virtual property corresponding to said online game account by said system;
according to said abnormal information of virtual property, sending an instruction of compensation, corresponding to said online game account, to a running server of said online game by said system; and
acquiring a form of request for handling of account theft by said system, and executing validity verification to said form of request for handling of account theft; generating said request for handling of account theft if said form of request passes said validity verification.

42. The non-transitory computer readable storage medium according to claim 41, wherein, said executing validity verification to said form of request for handling of account theft comprises following step:
judging whether said form of request for handling of account theft satisfies one or any combinations of following conditions by said system:
whether said online game account contained in said form of request for handling of account theft is a valid account;
whether a name of an online game character corresponding to said online game account is correct;
whether a level of said online game character corresponding to said online game account reaches a preset level; and
if so, said form of request for handling of account theft passes said validity verification.

43. The non-transitory computer readable storage medium according to claim 41, wherein, said step of acquiring abnormal information of virtual property corresponding to said online game account by said system comprises following sub-steps:
acquiring login information corresponding to said online game account by said system;
according to said login information, acquiring login addresses corresponding to said online game account and determining a commonly used login address corresponding to said online game account by said system; and
judging whether there is a login address, which is different from said commonly used login address, contained in said login addresses by said system; if so, said online game account is judged as an abnormal online game account.

44. The non-transitory computer readable storage medium according to claim 43, wherein, said step of acquiring abnormal information of virtual property corresponding to said online game account by said system further comprises following sub-steps:
when said online game account is an abnormal online game account, acquiring login time and logout time contained in said login information corresponding to said login address which is different from said commonly used login address, and then acquiring an abnormal login period corresponding to said online game account according to said login time and logout time by said system;
acquiring virtual property flowing information corresponding to said online game account by said system, and judging whether there is virtual property flowing out from said online game account during said abnormal login period, according to said virtual property flowing information; and
if so, said out flowing virtual property during said abnormal login period is judged as stolen virtual property.

45. The non-transitory computer readable storage medium according to claim 44, wherein, said step of according to said abnormal information of virtual property, sending an instruction of compensation, corresponding to said online game account, to the running server of said online game according to said abnormal information of virtual property by said system is specified as the following step:
sending, to said running server of said online game, an instruction of adding said stolen virtual property to said abnormal online game account by said system; and
acquiring said stolen virtual property flowing information by said system, and according to said abnormal information of virtual property, determining a destination online game account to which said stolen virtual property flows.

46. The non-transitory computer readable according to claim 45, wherein, the step of sending said instruction of compensation, corresponding to said online game account, to the running server of said online game according to said abnormal information of virtual property by said system is specified as the following steps:
sending, to said running server of said online game, an instruction of deleting said stolen virtual property from said destination online game account; and sending, to said running server of said online game, an instruction of adding said stolen virtual property to said abnormal online game account by said system.
